(19) United States
(12) Patent Application Publication
(10) Pub. No.: US 2016/0220434 A1
(43) Pub. Date: Aug. 4, 2016

(54) EXTENDABLE HOSPITAL BED

(71) Applicant: Luping Li, Ningbo (CN)

(72) Inventor: Luping Li, Ningbo (CN)

(21) Appl. No.: 15/095,068

(22) Filed: Apr. 10, 2016

Related U.S. Application Data
(63) Continuation-in-part of application No. PCT/CN2014/075887, filed on Apr. 22, 2014.
Application No. PCT/CN2014/075887 is a continuation-in-part of application No. PCT/CN2014/075882, filed on Apr. 22, 2014.
Application No. PCT/CN2014/075882 is a continuation-in-part of application No. PCT/CN2014/075880, filed on Apr. 22, 2014.

(30) Foreign Application Priority Data
Mar. 11, 2014 (CN) 201410087502.2
Mar. 11, 2014 (CN) 201410087540.8
Mar. 11, 2014 (CN) 201410087580.2

(51) Int. Cl. A61G 7/002

(52) U.S. Cl. CPC A61G 7/002

(57) ABSTRACT

An extendable hospital bed comprises a bed frame for supporting a bed surface and bed legs arranged at two ends of the bed frame, wherein width extending frames and a bed head extending frame located at one end of the bed frame are arranged on the bed frame, the width extending frames are horizontally and parellelly arranged along the bed frame, the bed frame, the width extending frame and the bed head extending frame are jointly laid to form the bed surface, a first hollow pipe is horizontally arranged and a second hollow pipe is longitudinally arranged on the bed frame, a third hollow pipe which is parallel to the first hollow pipe is arranged on the bed head extending frame, a second inserting pipe which is inserted into the second hollow pipe in a sliding mode is fixedly connected with the bed head extending frame, one end of a right angle bent inserting pipe is inserted into the third hollow pipe in a sliding mode, the other end is inserted into an adjacent width extending frame longitudinal hollow pipe, the bed head extending frame is connected with a longitudinal support bar, one end of the longitudinal support bar is connected with the bed head extending frame, and the other end is dragged to the bed frame.

### CROSS-REFERENCE TO RELATED APPLICATIONS

This application is a continuation-in-part of International Patent Application No. PCT/CN2014/075887 with an international filing date of Apr. 22, 2014, designating the United States, now pending, and further claims priority benefits to Chinese Patent Application No. 201410087502.2, filed Mar. 11, 2014; this application is a continuation-in-part of International Patent Application No. PCT/CN2014/075882 with an international filing date of Apr. 22, 2014, designating the United States, now pending, and further claims priority benefits to Chinese Patent Application No. 201410087580.2 , filed Mar. 11, 2014; and this application is a continuation-in-part of International Patent Application No. PCT/CN2014/075880 with an international filing date of Apr. 22, 2014, designating the United States, now pending, and further claims priority benefits to Chinese Patent Application No. 201410087540.8 , filed Mar. 11, 2014. The contents of all of the aforementioned applications, including any intervening amendments thereto, are incorporated herein by reference.

### TECHNICAL FIELD

The present invention elates to a hospital bed, more particularly, to an extendable hospital bed which can broaden and lengthen.

### BACKGROUND OF THE PRESENT INVENTION

The length and width of the bed surface for existing hospital beds are fixed, and the hospital beds generally depend on wheels under bed legs for moving. The move of hospital beds is limited by the width of door for those rooms with narrow door, when the width of door is less than that of hospital beds, the hospital beds are hard to move in or out. Especially when disasters and accidents happen, such as fire and earthquake, it is a threat to patients' life if the hospital beds cannot pass through smoothly.

Besides, in the sales and transportation process-of hospital beds, the width and total length cannot be changed although normal hospital beds are folding structure, so that the volume is still large and large space need to be occupied, which increases the transportation cost. From the view of move and transport of hospital beds the size of hospital beds needs to be reduced.

However, from the view of use, patients have greater requirements on the length and width of hospital beds, so larger size is needed. Moreover, in general, hospital beds have normal size, however, for those much taller patients, the hospital beds are not long and wide enough. The size of bed surface for existing hospital beds cannot be adjusted, which brings inconvenience.

### SUMMARY OF THE PRESENT INVENTION

The present invention is to overcome above shortcomings of prior art by providing a hospital bed that the size of bed surface can be adjusted.

The extendable hospital bed of the present invention comprises a bed frame for supporting a bed surface and bed legs arranged at two ends of the bed frame, wherein the width extending frames and a bed head extending frame located at one end of the bed frame are arranged on the bed frame, the width extending frames are horizontally and parellelly arranged along the bed frame, the width extending frame and the bed head extending frame on the bed frame are jointly laid to form the bed surface.

A first hollow pipe is horizontally arranged along the bed frame a first inserting pipe which can be inserted into the first hollow pipe in a sliding mode is arranged on the width extending frames, a horizontal supporting bar is arranged on the width extending frames, one end of the horizontal supporting bar is connected to the width extending frames, the other end is dragged to the bed frame.

A second hollow pipe is longitudinally arranged along the bed frame, a third hollow pipe which is parallel to the first hollow pipe is arranged on the bed head extending frame, a second inserting pipe which is inserted into the second hollow pipe in a sliding mode is fixedly connected with the bed head extending frame, one end of a right angle bent inserting pipe is inserted into the third hollow pipe in a sliding mode, the other end is inserted into an adjacent width extending frame longitudinal hollow pipe, the bed head extending frame is connected with a longitudinal support bar, one end of the longitudinal support bar is connected with the bed head extending frame, and the other end is dragged to the bed frame.

The bed frame, the third hollow pipe, and the right angle bent inserting pipe are located on the same plane, and the second hollow pipe and the second inserting pipe are located below the plane.

The width extending frames, the first hollow pipe, the third hollow pipe, and the right angle bent inserting pipe are located on the same plane, and the second hollow pipe and the second inserting pipe are located below the plane.

Furtherly, the width extending frames are provided with a first bolt assembly, the bolt assembly comprises a torsion shaft, the torsion shaft is connected with a resetting torsion spring, one end of the torsion shaft is connected with a toggle handle, the other end is connected with the first pin; the first bolt is fitted with a first slot on the hospital beds to fix the location of width extending frames.

Furtherly, the bed head extending frame is connected with a second bolt assembly, the second bolt assembly comprises a second bolt, the resetting torsion spring is provided on the inner cavity on a bolt bush of the second bolt, the nut is connected beside the bolt bush, the second bolt is fitted with a second slot on the hospital beds to fix the location of bed head extending frame; the tail of the second bolt is connected with a stay, cord by which it can be pulled out from the second slot.

In the use process of the present invention, the width extending frames can be horizontally moved as needed, the horizontal supporting plate is dragged to the bed frame to form extendable bed surface. As for the part of bed head, due to the sliding inserting of both ends of the right angle bent inserting pipe, the width or length of bed surface can be respectively adjusted, and the width and length of bed surface can be adjusted simultaneously, the completeness of bed surface can be kept in the adjusting process, Longitudinal connection parts are provided between the bed head extending frame and the bed frame as forced parts, that is, the second inserting pipe and the second hollow pipe, and the second inserting pipe and the second hollow pipe are dislocated with the plane of the bed frame, the bad head extending frame and the width extending frames, which can effectively reduce force of the right angle bent pipe, so that the sliding of the right angle bent pipe is smooth and the adjusting process of the bed surface is good. In the adjusting process of the bed head extending frame, the horizontal supporting plate is dragged to the bed frame to form extendable bed surface.

The advantages of the present invention: the width and length of bed surface can be adjusted conveniently and smoothly, the mechanical structure is solid and durable; it is convenient to move in the hospital, easy to transfer patients and ensure patients' life when disasters and accidents happen such as fire and earthquake; it is convenient to reduce transportation size, and adjust the size of bed as patients needed has excellent humanization design.

### BRIEF DESCRIPTION OF THE DRAWINGS

FIG. 1 is a top view of the present invention;

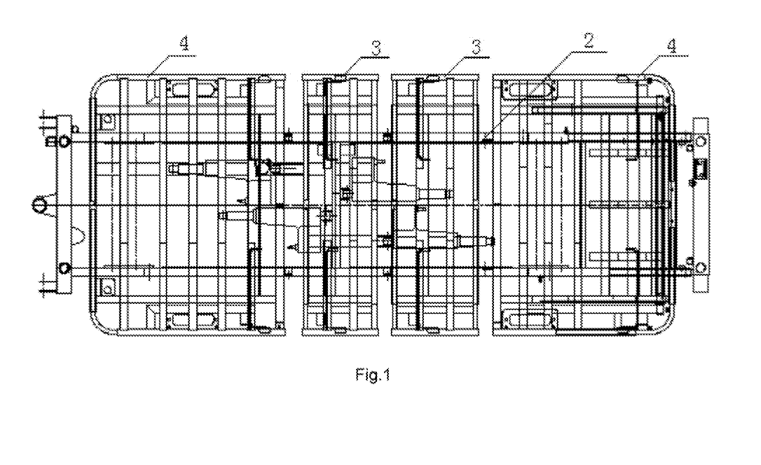

FIG. 2 is a front view of the present invention;

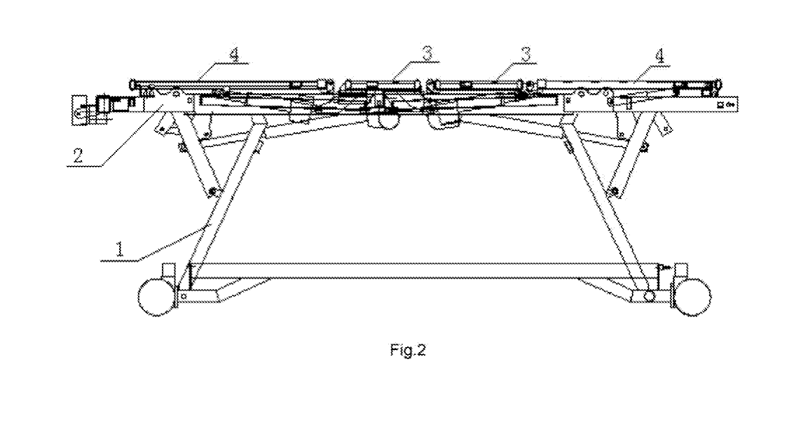

FIG. 3 is a partially top view of the width extending frames;

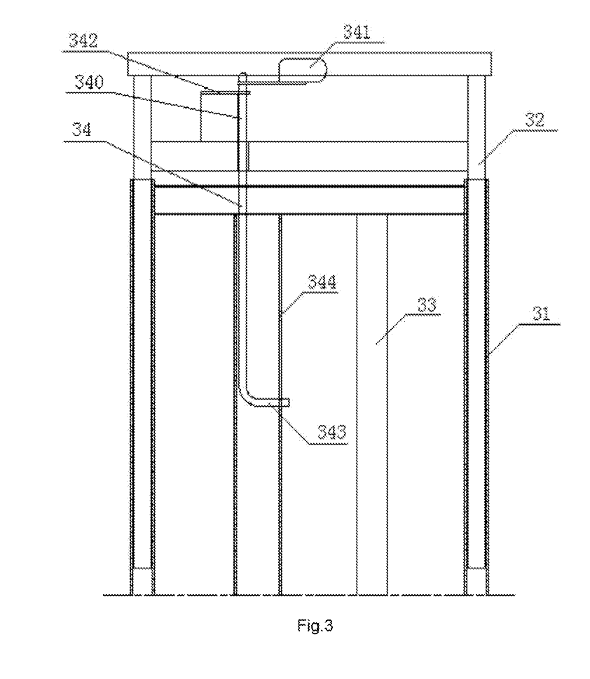

FIG. 4 is a partially top view of the bed head extending frame;

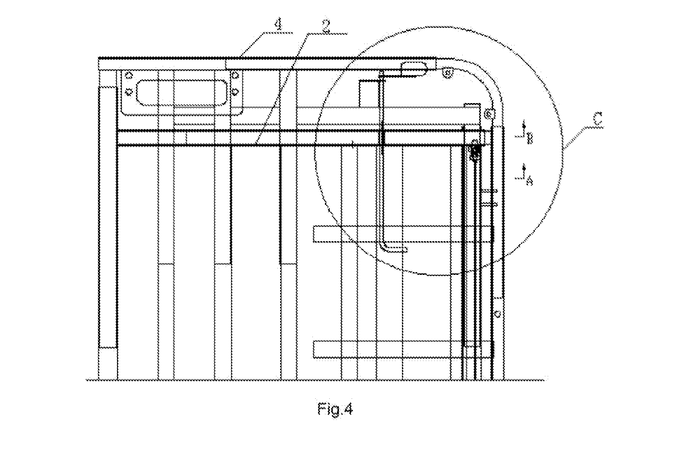

FIG. 4a is a section view of A-A direction of FIG. 4;

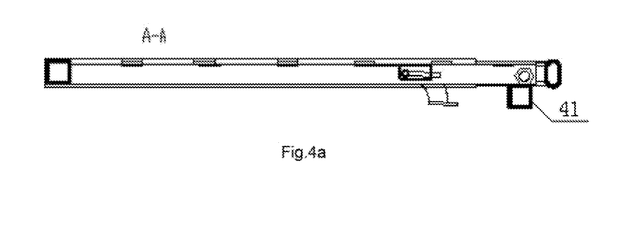

FIG. 4b is a section view of B-B direction of FIG. 4;

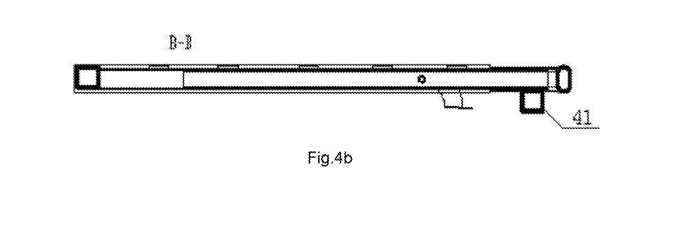

FIG. 4c is a partially enlarged view of C part of FIG. 4;

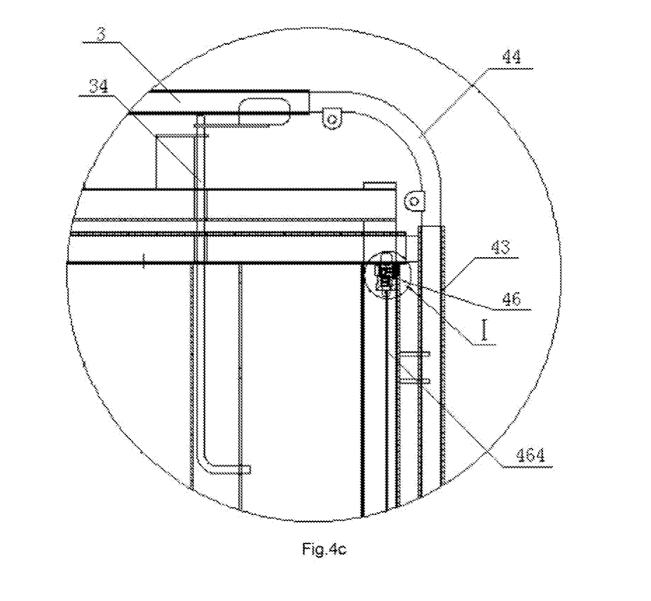

FIG. 4d is a partially enlarged view of I part of FIG. 4c;

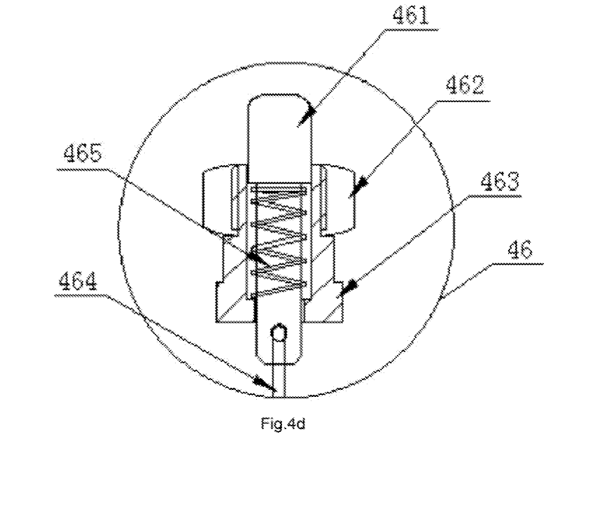

FIG. 5a is a partially graphic del of the bed head extending frame;

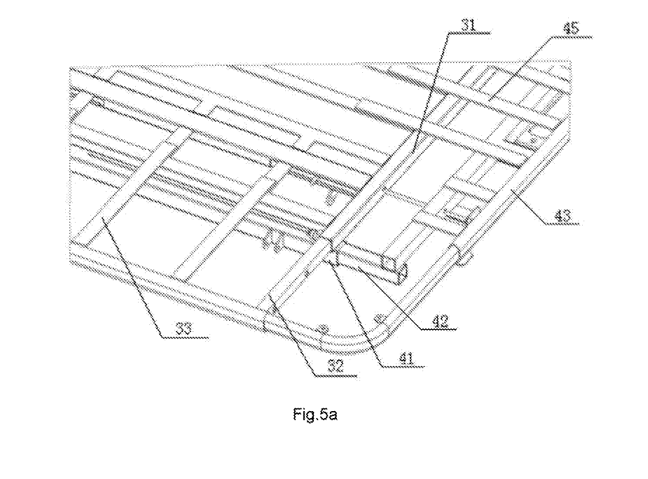

FIG. 6b is a partially graphic model of another direction of the bed head extending frame;

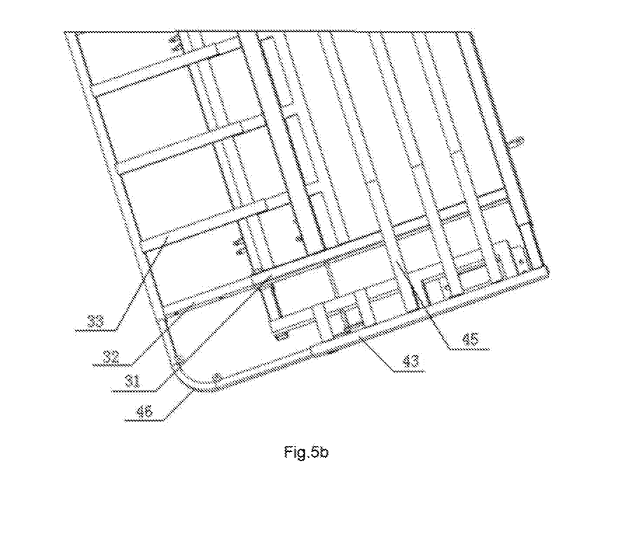

FIG. 6a is a partially graphic model of the width extending frames;

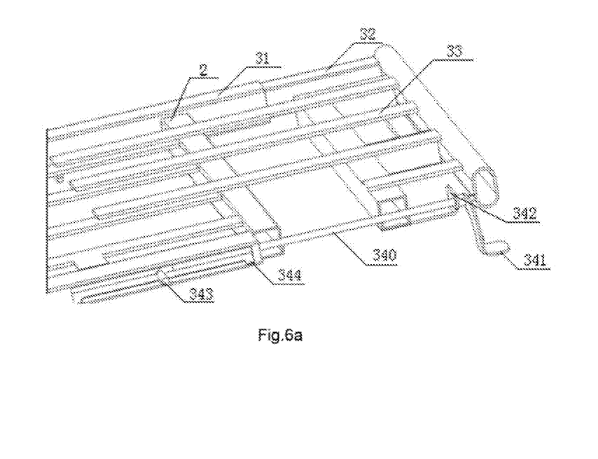

FIG. 6b is a partially graphic model of another direction of the width extending frames;

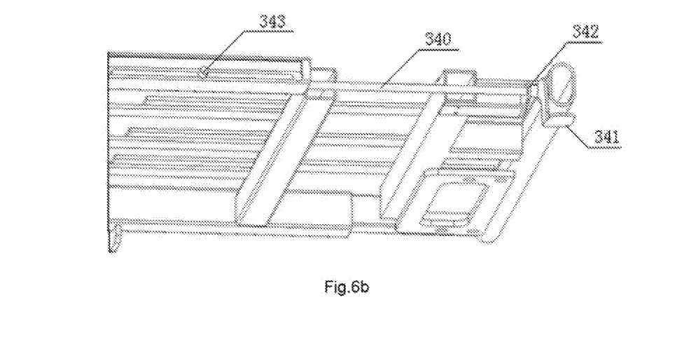

FIG. 6c is a partially graphic model of another direction of the width extending frames;

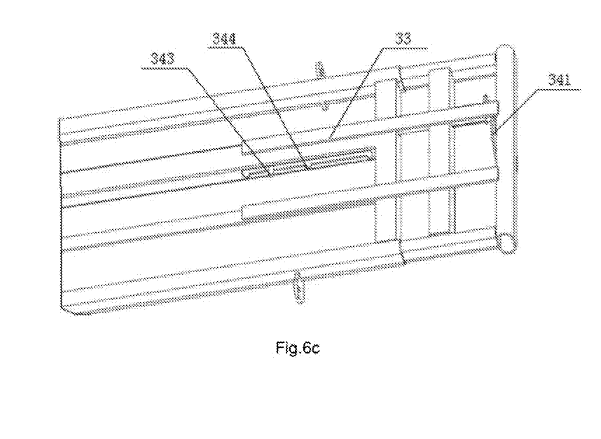

FIG. 6d is a partially graphic model of another direction of the width extending frames.

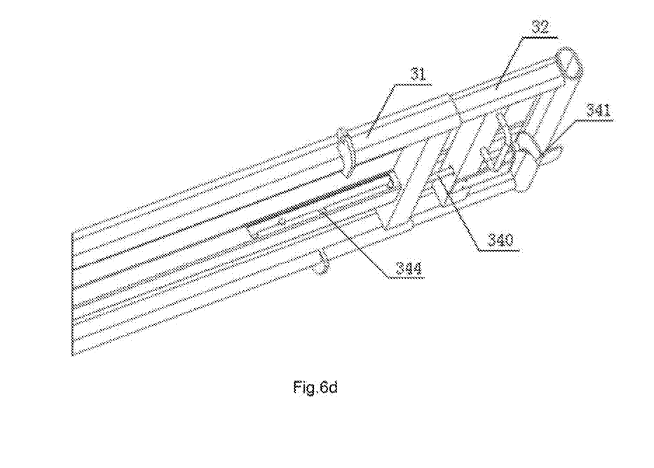

### DETAILED DESCRIPTION OF PREFERRED EMBODIMENTS

Refer to drawings:

The extendable hospital bed of the present invention comprises a bed frame 2 for supporting a bed surface and bed legs 1 arranged at two ends of the bed frame 2, characterized in that the width extending frames 3 and a bed head extending frame 4 located at one end of the bed frame 2 are arranged on the bed frame 2, the width extending frames 3 are horizontally and parellelly arranged along the bed frame 2, the width extending frames 3 and the bed head extending frame 4 on the bed frame 2 are jointly laid to form the bed surface.

A first hollow pipe 31 is horizontally arranged along the bed frame 2, a first inserting pipe 31 which can be inserted into the first hollow pipe 32 in a sliding mode is arranged on the width extending frames 3, a horizontal supporting bar 33 is arranged on the width extending frames 3, one end of the horizontal supporting bar 33 is connected to the width extending frames 3, the other end is dragged to the bed frame 2.

A second hollow pipe 41 is longitudinally arranged along the bed frame 2, a third hollow pipe 31 which is parallel to the first hollow pipe 43 is arranged on the bed head extending frame 4, a second inserting pipe 41 which is inserted into the second hollow pipe 42 in a sliding mode is fixedly connected with the bed head extending frame 4, one end of a right angle bent inserting pipe 44 is inserted into the third hollow pipe 43 in a sliding mode, the other end is inserted into an adjacent width extending frame longitudinal hollow pipe, the bed head extending frame 4 is connected with a longitudinal support bar 45, one end of the longitudinal support bar 45 is connected with the bed head extending frame 4, and the other end is dragged to the bed frame 2.

The bed frame 2, the width extending frames 3, the first hollow pipe 31, the third hollow pipe 43, and the right angle bent inserting pipe 44 are located on the same plane, and the second hollow pipe 41 and the second inserting pipe 42 are located below the plane.

The width extending frames 3, the first hollow pipe 31, the third hollow pipe 43, and the right angle bent inserting pipe 44 are located on the same plane, and the second hollow pipe 41 and the second inserting pipe 42 are located below the plane.

Furtherly, the width extending frames 3 are provided with a first bolt assembly 34, the bolt assembly 34 comprises a torsion shaft 340, the torsion shaft 340 is connected with a resetting torsion spring 342, one end of the torsion shaft 340 is connected with a toggle handle 341, the other end is connected with the first pin 343; the first bolt 343 is fitted with a first slot on the hospital beds to fix the location of width extending frames.

Furtherly, the bed head extending frame 4 is connected with a second bolt assembly 46, the second bolt assembly 46 comprises a second bolt 461, the resetting torsion spring 465 is provided on the inner cavity on a bolt bush 463 of the second bolt 461, the nut 462 is connected beside the bolt bush 463, the second bolt 461 is fitted with a second slot on the hospital beds to fix the location of bed head extending frame; the tail of the second bolt 461 is connected with a stay cord 464 by which it can be pulled out from the second slot.

In the use process of the present invention, the width extending frames can be horizontally moved as needed, the horizontal supporting plate is dragged to the bed frame to form extendable bed surface. As for the part of bed head, due to the sliding inserting of both ends of the right angle bent inserting pipe, the width or length of bed surface can be respectively adjusted, and the width and length of bed surface can be adjusted simultaneously, the completeness of bed surface can be kept in the adjusting process. Longitudinal connection parts are provided between the bed head extending frame and the bed frame as forced parts, that is, the second inserting pipe and the second hollow pipe, and the second inserting pipe and the second hollow pipe is dislocated with the plane of the bed frame, the bed head extending frame and the width extending frames, which can effectively reduce force of the right angle bent pipe, so that the sliding of the right angle bent pipe is smooth and the adjusting process of the bed surface is good. In the adjusting process of the bed head extending frame, the horizontal supporting plate is dragged to the bed frame to form extendable bed surface.

The embodiments of the present invention are some examples, and the present invention not limited thereto while it should be noted to those skilled in the art that equivalent technological means based on the conception of the present invention are also considered within the protective scope of the present invention.

I claim:

1. An extendable hospital bed, comprising a bed frame for supporting a bed surface and bed legs arranged at two ends of the bed frame, characterized in that the width extending frames and a bed head extending frame located at one end of the bed frame are arranged on the bed frame, the width extending frames are horizontally and parellelly arranged along the bed frame, the bed frame, the width extending frame and the bed head extending frame on the bed frame are jointly laid to form the bed surface;
A first hollow pipe is horizontally arranged along the bed frame, a first inserting pipe which can be inserted into the first hollow pipe in a sliding mode is arranged on the width extending frames, a horizontal supporting bar is arranged on the width extending frames, one end of the horizontal supporting bar is connected to the width extending frames, the other end is dragged to the bed frame;
A second hollow pipe is longitudinally arranged along the bed frame, a third hollow pipe which is parallel to the first hollow pipe is arranged on the bed head extending frame, a second inserting pipe which is inserted into the second hollow pipe in a sliding mode is fixedly connected with the bed head extending frame, one end of a right angle bent inserting pipe is inserted into the third hollow pipe in a sliding mode, the other end is inserted into an adjacent width extending frame longitudinal hollow pipe, the bed head extending frame is connected with a longitudinal support bar, one end of the longitudinal support bar is connected with the bed head extending frame, and the other end is dragged to the bed frame, the width extending frames, the first hollow pipe, the third hollow pipe, and the right angle bent inserting pipe are located on the same plane, and the second hollow pipe and the second inserting pipe are located below the plane.

2. The extendable hospital bed according to claim 1, characterized in that the width extending frames are provided with first bolt assembly, the bolt assembly comprises a torsion shaft, the torsion shaft is connected with a resetting torsion spring, one end of the torsion shaft is connected with a toggle handle, the other end is connected with the first pin; the first bolt is fitted with a first slot on the hospital beds to fix the location of width extending frames.

3. The extendable hospital bed according to claim 1, characterized in that the bed head extending frame is connected with a second bolt assembly, the second bolt assembly comprises a second bolt, the resetting torsion spring is provided on the inner cavity on a bolt bush of the second bolt, the nut is connected beside the bolt bush, the second bolt is fitted with a second slot on the hospital beds to fix the location of bed head extending frame; the tail of the second bolt is connected with a stay cord by which it can be pulled out from the second slot.
